(19) United States
(12) Patent Application Publication
(10) Pub. No.: US 2010/0154487 A1
(43) Pub. Date: Jun. 24, 2010

(54) Double Cylinder Lock

(76) Inventor: Shik Kui Cheung, (US)

Correspondence Address: Victor R. Anderson, 15 Newton Lane, Trumbull, CT, 06611, US

(21) Appl. No.: 12/719,151

(22) Filed: Mar. 8, 2010

Related U.S. Application Data
(60) Provisional application No. 61/210,134, filed on Mar. 16, 2009.

(30) Foreign Application Priority Data
Aug. 5, 2008 (TH) 0803000954
Sep. 5, 2008 (TH) 0803001094

(51) Int. Cl. E05B 67/24

(52) U.S. Cl. 70/35

(57) ABSTRACT

By providing a lock such as a padlock or deadbolt lock wherein the components forming two wafer or pin cylinder assemblies, interconnected so that one key and wafer cylinder locks and unlocks the shackle or deadbolt and the other key and wafer cylinder when key actuated blocks and unblocks access to the first key cylinder's key insertion hole therefore double locking the overall mechanism, resulting in increased security, creating multi-levels of security and various additional methods of security which is attained through standard key and cylinder key bit configurations.

### RELATED APPLICATIONS

Thailand Utility patent application number 0803000954 Filed 5 Aug. 2008

Thailand Utility patent application number 0803001094 Filed 5 Sep. 2008

U.S. Provisional Patent Application No. 61/210,134 Filing date Mar. 16, 2009 Confirmation No. 4260

### TECHNICAL FIELD

This invention relates to a locking mechanism that contains two independent lock cylinders incorporated within a single lock and keys for higher level security and/or for overriding multiple level or levels of security.

### BACKGROUND OF THE INVENTION

Improving security against theft, terrorism, vandalism and personal safety is a never ending task for individuals, law enforcement agencies, retail establishments, companies, institutions and governments among others. Depending on what is being protected, various levels of security or unique methods of security are required or desired in many cases.

It is the purpose of this invention to provide alternatives in the selection of security devices that enhances the level of security and/or the method of security to be used to obtain the desired protection results. Further, to provide for these alternatives in a cost effective manner.

### SUMMARY OF THE INVENTION

By employing the present invention, the prior art drawbacks are overcome therefore providing for cost effective multi-level security within familiar locking devices such as padlocks, locker locks, entry door locks, gun and ammunition locks, cabinet locks, desk locks, lockable container locks, gate locks and other similar applications for locking devices.

Most low cost lock devices such as padlocks, cabinet locks and entry door locks operate to lock and unlock the element or content that they are protecting as a single function. If an individual has a key, he or she can lock and unlock the element as often or whenever they choose if no other security device or practice is part of the element protection. Further, if multiple individuals all have keys compatible to the lock device, they all have access as often or whenever they choose. The more persons with keys basically the less overall security exists.

This new invention adds several additional levels to basic lock and unlock security by incorporating two or more sub-mechanism wafer or pin cylinders, either all wafer cylinders, or all pin cylinders or a combination of wafer and pin cylinders within one locking device such as a padlock, locker lock, entry door lock, cabinet lock or other similar familiar locks. In addition this invention includes a conventional single set of wafers or pins within each cylinder.

For example, the new invention can be configured to allow for one lock sub-mechanism cylinder within the overall locking device to function as a conventional lock and have another sub-mechanism cylinder within the same overall locking device to lock the first sub-mechanism creating a dual level locking system with two or more cylinders having the same key cut so one key operates both or all cylinders within the overall locking device. In order to breach the overall locking device, one would have to pick one sub-mechanism and then pick the other sub-mechanism(s) to open the lock. Picking only one of the sub-mechanisms would not allow the lock to open. Or, one would have to break or physically damage two or more cylinders in such a way as to unlock or release the lock instead of one cylinder in a conventional lock mechanism. Breaking or damaging only one of the sub-mechanisms in such a manner would not allow the lock to open. Or one would have to obtain a duplicate single key or have one unauthorized key made and then use it to unlock two or more cylinders within the lock mechanism.

Another example is that the new invention can be configured to allow for one lock sub-mechanism cylinder within the overall locking device to function as a conventional lock and have another sub-mechanism cylinder keyed differently within the same overall locking device to lock the first sub-mechanism creating a dual level locking system with two or more cylinders each having a different key cut. In order to breach the overall locking device, one would have to pick one sub-mechanism and then pick the other sub-mechanism(s) to open the lock similar to the first example. Picking only one of the sub-mechanisms would not allow the lock to open. Or, one would have to break or physically damage two or more cylinders in such a way as to unlock or release the lock instead of one cylinder in a conventional lock mechanism. Breaking or damaging only one of the sub-mechanisms in such a manner would not allow the lock to open. Or one would have to obtain two or more different cut unauthorized duplicate keys or have two or more unauthorized keys made and then use them to unlock two or more cylinders within the lock mechanism. This configuration would add another level of security if the two or more different cut keys were held in two different locations by one person authorized to have access to the locking and unlocking of the lock mechanism. Another level of security could be realized if two or more persons were each authorized to hold one different key and therefore the locked element or contents could only be accessed with two or more authorized persons together.

Another level of security to the second example about configuring two or more sub-mechanism cylinders with different key cuts would be where the owner of the locked element or contents would want to allow access to other authorized persons during designated periods of time such as employees authorized to access inventory during business hours only. In such a case, the owner would have the only key for the sub-mechanism cylinder that locks the other first cylinder and authorized employees would each have a key for the first sub-mechanism cylinder. Therefore the owner could unlock the overriding second sub-mechanism cylinder at the start of the authorized period of time reducing the security to the first sub-mechanism cylinder allowing access to unlocking and relocking the element or contents by all authorized persons holding the first cylinder keys. At the end of the designated period of time, the owner could then lock the second overriding sub-mechanism cylinder with his exclusive key therefore in effect locking out the other key holding persons during the designated non-authorized access period of time for controlled limited access. This type of dual key cut configuration would have numerous applications such as but not limited to an institution or school main gate or main entry door allowing authorized persons and students to enter during authorized periods only and yet restrict non-authorized persons access at all times.

Another level of security to the second example about configuring two or more sub-mechanism cylinders with different key cuts would be applications for security “lock-down”. An example would be for a dual cylinder padlock or dual cylinder locker lock configured for school lockers. Each student would have his or her own special key cut that would function the first cylinder only. The second overriding cylinder would be keyed alike, i.e. one key cut for all the locks used on all the lockers, and this sub-mechanism cylinder would normally be left unlocked with the key(s) held by a security official or school principal or both. Should suspicion regarding the possibility of weapons, drugs, stolen property or other illicit contents arise, the specific locker could be “locked down” immediately by the security official and reopened under controlled conditions with school officials, the student, his or her parents, guardians and police present. During this “lock-down” period, the student could not open the locker to remove the contents. The double lock mechanism could be configured so that the “lock-down” key will only “lock-down” and “un-lock-down” the double locking mechanism and not lock and unlock the sub-mechanism student cylinder.

### THE DRAWINGS

For a fuller understanding of the nature and objects of the present invention, reference should be made to the following drawings, in which:

FIG. 1 is a front elevation view, showing the new mechanism for a padlock application with one view as a fully assembled padlock with one key for each of two cylinders each containing a conventional wafer sub-mechanism and another view of the padlock with the major function components disassembled.

FIG. 2 is a 3-dimensional perspective of the new mechanism with conventional wafer cylinders for a padlock application disassembled to show the major components.

FIG. 3 is a combination front elevation view and 3-dimensional perspective of the new mechanism with two conventional wafer cylinders for a padlock application showing the assembled and disassembled mechanism components and how they are assembled together to accomplish the double deadbolt locking and unlocking of the shackle shown in the component positions with the shackle in the unlocked position.

FIG. 4 is a front elevation view of the new mechanism with two conventional wafer cylinders for a padlock application showing the assembled and disassembled mechanism components and how they are assembled together to accomplish the double deadbolt locking and unlocking of the shackle shown in the component positions with the shackle in the locked position.

FIG. 5 is a 3-dimensional perspective of the new mechanism with two conventional wafer cylinders for a padlock application disassembled to show the major components for the key hole entry blocking function and a bottom elevation view of one component (11) that is used in the lock function “indicator viewing window”.

FIG. 6 is a bottom elevation view of the new mechanism for a padlock application showing the three positions of the key hole entry blocking function.

FIG. 7 is a bottom elevation view of the new mechanism for a padlock application showing the two key hole entry and the three positions of the key hole entry blocking function and the three position of the lock function “indicator viewing window”

FIG. 8 is a picture (image) of the new mechanism for a padlock application.

FIG. 9 is a picture (image) of the new mechanism for a typical deadbolt locker lock application commonly used on school student and institutional personnel lockers.

### DETAILED DESCRIPTION

Most locking mechanisms available that are cost effective perform a single function such as locking a gate, a door, a box, a cabinet among many other things. Usually the lock has one key cut code for many locks or many different key codes for many locks and in the case of the highest security, one different key code for each individual lock. In these instances the security level as applied to the lock used is determined by three factors. {a} . . . how easy it is to obtain a duplicate key(s) {b} . . . how easy it is to pick the lock {c} . . . how easy it is to break, damage or cut the lock to force it open.

Other locking mechanisms available that are cost effective allow for master keying a series of locks in which each have their own individual key code and one or more master keys that will override the individual keys by locking and unlocking any lock within the series. A typical example of an application for a series of locks with individual keys and a master key that will open all of the locks in a series is a business with numerous employee desks each assigned to an person whereby each person would have their own individual key that will open only their own desk. A supervisor would hold a master key to open all of the desks or any specific desk if the need arose. Another example would be a school that had many students each assigned a locker with its own key code. A security official would hold a master key that would lock and unlock all the lockers.

Most locking mechanisms available that are cost effective have the security at a fixed level and therefore lacks flexibility. Security flexibility can usually only be obtained by changing from one type of lock to another for example, from a lighter duty easier to pick lock to a heavier stronger more solid lock that is extremely difficult to pick.

It is the purpose of the new invention to make available cost effective locks that has characteristics for various security levels within the same lock mechanism and to make available a lock with increased resistance to obtaining illicit keys, picking the mechanism to a point of unlocking, and breaking, damaging, forcing or cutting the lock to a point of unlocking. In addition to adding more flexibility and security add new levels of use through key access authorization control on when and how the lock is used.

In accordance with the new invention lock mechanism and its characteristics, many of the limitations and problems that exist with conventional locks can be alleviated, minimized or eliminated.

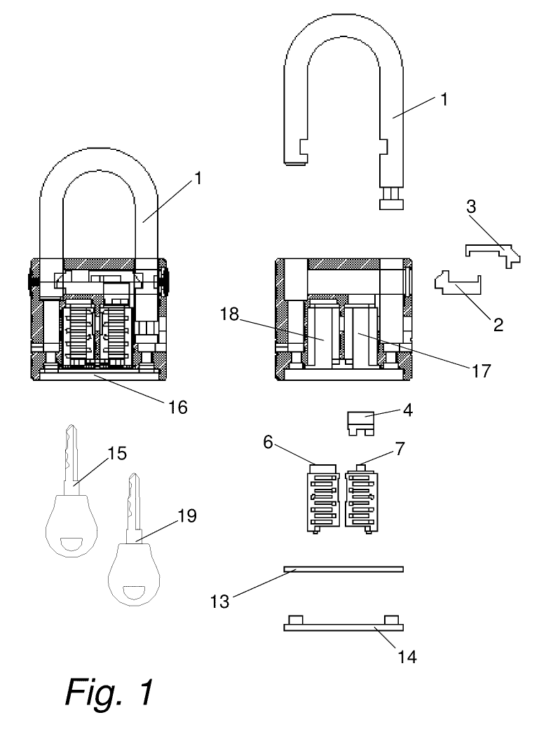

FIG. 1 shows the new invention lock mechanism as a padlock application in the assembled and disassembled condition and only some of the components shown within this section. The lock mechanism functions with two separate lock cylinders (6) and (7) within one lock and each of the two lock cylinders would normally be keyed with its own unique key code so that one key (15) would only function cylinder (6) and the other key (19) would only function cylinder (7).

For simple double cylinder security, both cylinders could have the same key code so that one key would function both cylinders which would afford flexibility to the lock user extending the option of single locking the lock by locking only one cylinder or double locking the lock by locking two cylinders with the convenience of one key. With both cylinders configured for the same key code, basic conventional security level would be attained by simple locking of the deadbolt functioning cylinder (7) only and not locking the double locking cylinder (6). To breach the lock, one would have to either obtain a duplicate key, pick lock cylinder (7) or break, damage, force or cut cylinder (7) to release the shackle and open the lock. Simple double locking security could be attained by the user using the one key code key to lock first the deadbolt locking cylinder (7) and then using the same key lock the double locking cylinder (6). To breach the lock when double locked, one would have to either obtain a duplicate key, pick both cylinders individually or break, damage, force or cut both cylinder (6 and cylinder (7) to release the shackle and open the lock, which would be a more difficult job than if only cylinder (7) was locked. An example of flexibility would be if the lock user for convenience could choose to use single locking of only one cylinder during the day and double locking overnight when burglaries most often are carried out.

For a higher security level, the lock mechanism would be configured so that one key code key (15) would function the double locking cylinder (6) and the other key code key (19) would function the other deadbolt locking cylinder (7). For simple single cylinder security, the user could lock and unlock the deadbolt cylinder (7) similar to a conventional lock. To breach the lock, one would have to either obtain a duplicate key, pick lock cylinder (7) or break, damage, force or cut cylinder (7) to release the shackle and open the lock. For added security, the user could lock both deadbolt locking cylinder (7) with key code key (19) and then using key code key (15) lock the double locking cylinder (6). To breach the double locked lock, one would have to either obtain two different duplicate keys, pick both lock cylinders (7) and (6) or break, damage, force or cut both cylinders (7) and (6) to release the shackle and open the lock. Added to the above flexibility and security, this configuration would allow for the lock owner, business supervisor, school or institution to distribute keyed alike keys (19) to authorized individuals such as employees or students so that they would have access to locking and unlocking the deadbolt cylinder (7) during designated periods of time. The lock owner, business supervisor, school or institution would control the designated access time periods through the use of key code key (15) by locking and unlocking the double cylinder (6) to correspond with designated access time.

Another level of security would be a key configuration whereby key code key (19) is keyed differently so that each deadbolt cylinder (7) is keyed differently to match only one key code key (19) . . . for example 200 locks with 200 different key code keys (19) matching 200 deadbolt cylinders (7) to be distributed to students or employees for individual lockers. Within the double cylinder locking mechanism, key code key (15) and double cylinder (6) would be keyed alike and one override key (15) would be retained by an authorized security official(s) only. In the event of suspicious or confirmed illegal activity related to drugs, weapons or stolen property for example, the security official could “lock down” one or more lockers depending on the circumstances therefore effectively locking the student(s) or employee(s) out and securing the illegal dangerous contents or evidence for a controlled reopening with the police, parents, other officials present. The key code key (15) for double cylinder (6) could be cut to function as a master key so that it would lock and unlock both cylinders (6) and (7) or only function cylinder (6).

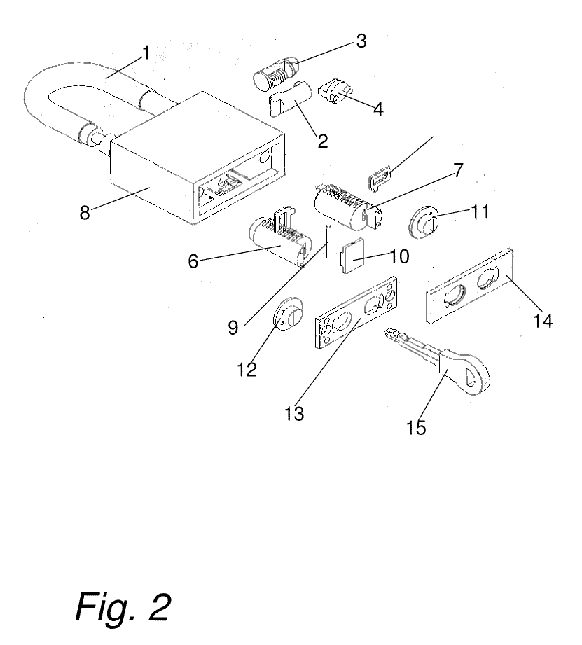

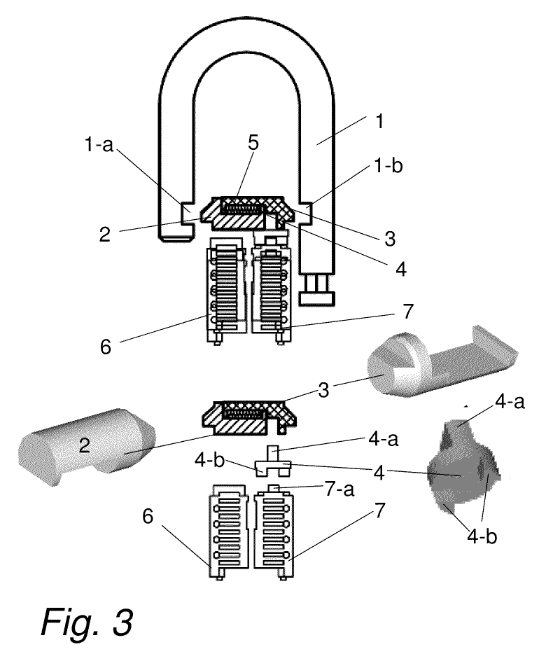

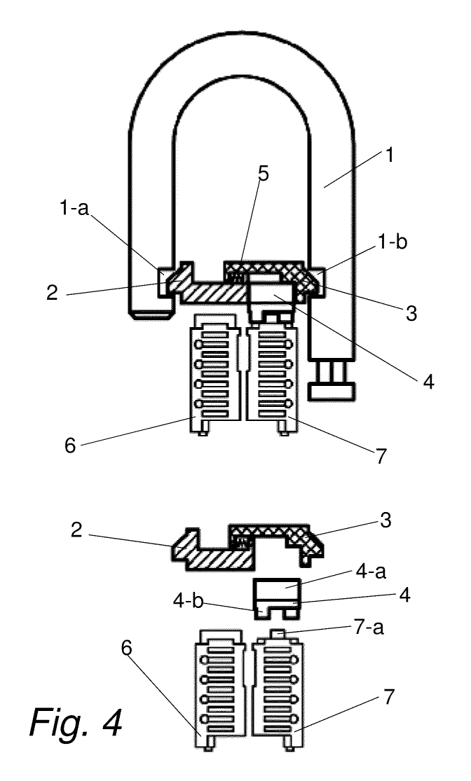

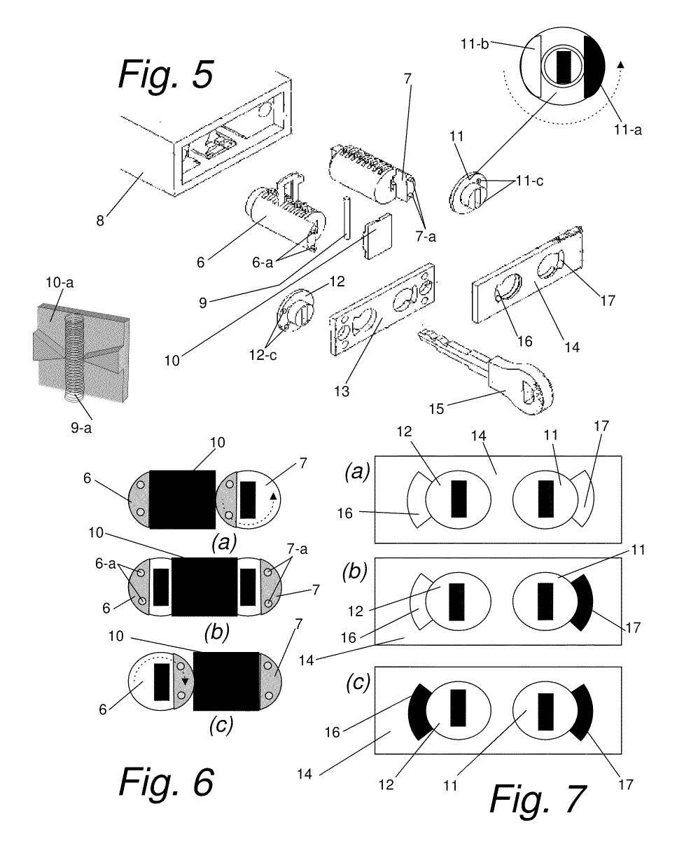

FIG. 2 shows the new invention lock mechanism as a padlock application in the disassembled condition with all of the major functional components included. Within this lock mechanism are three separate operational functions that interact with one another to form the overall total lock function and operating features. First is the deadbolt function (2) and (3) locking and unlocking the shackle (1) using components (4) and (7) which is described in FIG. 3 DETAILED DESCRIPTION and in FIG. 4 DETAILED DESCRIPTION following this section. Second is the key hole entry security blocking door (10) function which is described in FIG. 5 DETAILED DESCRIPTION, FIG. 6 DETAILED DESCRIPTION AND FIG. 7 DETAILED DESCRIPTION. The third function is the visual indicator window function described in FIG. 5 DETAILED DESCRIPTION and in FIG. 7 DETAILED DESCRIPTION.

FIG. 3 shows an internal view of the interaction of components that locks the shackle (1) inside of the lock body or housing. This view shows the first function which is the deadbolt (2) and (3) locking and unlocking the shackle (1) function. This view shows the deadbolts (2) and (3) in the unlocked disengaged position out of the shackle deadbolt slots (1-a) and (1-b) in which the deadbolts (2) and (3) are positioned laterally together by the compression spring force of spring (5). These views are shown outside of the lock body or housing internal mating cavities for clarity. Locking and unlocking the shackle (1) is accomplished by laterally moving deadbolt (2) and deadbolt (3) apart or together. The lateral movement of (2) and (3) together in the assembled together position is caused by the compression spring (5) expansion force and the lateral movement of (2) and (3) apart is caused by rotary component (4) when it is rotated 90 degrees. When rotary component (4) is rotated 90 degrees, the bar protrusion (4-a) rotates from a vertical position to a horizontal position forcing the deadbolts (2) and (3) apart and will hold the apart position when horizontal due to the compression spring (5) expansion constant force forcing the flat ends of the rotary bar protrusion (4-a) against the flat surfaces of the deadbolts (2) and (3). Rotary component (4) is rotated 90 degrees whenever the deadbolt lock cylinder (7) is rotated 180 degrees with the key inserted and rotated 180 degrees. It should be noted at this point that double cylinder (6) plays no direct role in the deadbolt activation function. It should also be noted that the reduction in rotation degrees of the rotary component (4) from 180 degree rotation of the cylinder (7) is accomplished by the location and size of the two identical triangular shaped stop protrusions (4-b) interacting with the bar protrusion (7-a) located on cylinder (7).

FIG. 4 shows an internal view of the interaction of components that locks the shackle (1) inside of the lock body or housing. This view shows the first function which is the deadbolt (2) and (3) locking and unlocking the shackle (1) function. This view shows the deadbolts (2) and (3) in the locked engaged position in the shackle deadbolt slots (1-a) and (1-b) in which the deadbolts (2) and (3) are positioned laterally apart by the compression spring force of spring (5) and the rotary component (4) bar protrusion (4-a). These views are shown outside of the lock body or housing internal mating cavities for clarity. The lateral movement of (2) and (3) together in the assembled together position is caused by the compression spring (5) expansion force and the lateral movement of (2) and (3) apart is caused by rotary component (4) when it is rotated 90 degrees. When rotary component (4) is rotated 90 degrees, the bar protrusion (4-a) rotates from a vertical position to a horizontal position forcing the deadbolts (2) and (3) apart and will hold the apart position when horizontal due to the compression spring (5) expansion constant force forcing the flat ends of the rotary bar protrusion (4-a) against the flat surfaces of the deadbolts (2) and (3). Rotary component (4) is rotated 90 degrees whenever the deadbolt lock cylinder (7) is rotated 180 degrees with the key inserted and rotated 180 degrees. It should be noted at this point that double cylinder (6) plays no direct role in the deadbolt activation function. It should also be noted that the reduction in rotation degrees of the rotary component (4) from 180 degree rotation of the cylinder (7) is accomplished by the location and size of the two identical triangular shaped stop protrusions (4-b) interacting with the bar protrusion (7-a) located on cylinder (7).

FIG. 5 shows the major components for the second function which is the key hole entry security blocking door (10) and the third function which is the visual indicator window.

The second function's purpose is to tie the deadbolt cylinder (7) into the double cylinder (6) so the overall lock mechanism yields a higher security level and more flexibility through more security options. This is accomplished by first ensuring that deadbolt cylinder (7) is in the locked position whereby the shackle is locked into the padlock lock body housing (8) then using the appropriate key inserted into double cylinder (6) and rotating the key and cylinder (6) 180 degrees into its locked position. This operational procedure moves the key hole blocking door (10) into a position whereby it is blocking the key hole for deadbolt cylinder (7) therefore preventing the key for cylinder (7) insertion into cylinder (7).

The third function of providing visual indicator windows (16) and (17) located in the bottom plate (14) which its purpose is to enable the visual determination of which cylinders are in the locked and/or unlocked positions without having to use the keys to determine this. It is the intention of the third feature to provide a means to look at the bottom of the lock housing to determine the locked or unlocked position of both cylinders. See FIG. 6 and FIG. 7 DESCRIPTION below for more detailed explanations.

FIG. 6 with FIG. 5 as reference shows the operational positions for the second feature which is the key hole entry security blocking door (10) function.

Note that the key hole security blocking door (10) could and probably would be color coded red or some other color for visual benefit when it is in either key hole blocking position.

Both cylinders (6) and (7) have half-moon protrusions located on the cylinder ends that contains the key entry holes that when rotated with the keys perform lateral movement of the key hole security blocking door in both left and right directions as shown in FIGS. 6 (a), (b) and (c). A tight coiled extension spring (9) and (9-a) inserts into end slots within lock body housing (8) and fits perpendicular between two triangle shaped protrusions on the back side of the key hole security blocking door (10) as shown in perspective component drawings (10-a) and (9-a). The rotational action of either cylinder (6) and (7) forces the key hole security blocking door (10) to move laterally left or right as explained above. When the key hole security blocking door is moved left or right, one of the two triangle protrusions will exert lateral pressure on the spring (9) and deform it at the point of contact in the direction of the key hole security blocking door (10) movement direction therefore creating spring return spring force on the keyhole security blocking door (10) to return to the middle position whereby the spring (9) is straight. When the spring (9) and (9a) is in the straight position, as shown in (9-a), the spring is devoid of force to force the keyhole security door (10) and (10-a) left or right as shown in FIG. 6 (b)

FIG. 6 (a) represents the position of the key hole security blocking door (10) with the padlock shackle unlocked from within the housing FIG. 5 (8) with the key hole security blocking door moved to the left by the rotational action of cylinder (7) half-moon protrusion forcing the key hole security blocking door in front of the key entry hole in cylinder (6) therefore blocking the key entry hole in cylinder (6). In this position, the padlock shackle is locked

FIG. 6 (b) represents the position of the key hole security blocking door (10) with the padlock shackle locked within the housing FIG. 5 (8) with the key hole security blocking door in the center position as shown in FIG. 6 (b) whereby both key hole entry holes are unblocked by the key hole security blocking door (10). The padlock is single locked only with one cylinder (7) locked in this position.

FIG. 6 (c) represents the position after cylinder (6) is rotated locked with its key forcing the key hole security blocking door (10) in front of key entry hole for cylinder (7). The padlock is double locked in this position with both cylinder (6) and cylinder (7) in their respective locked positions.

FIG. 7 with FIG. 5 and FIG. 6 as reference shows the positions of the visual indicator windows FIG. 7 (16) and (17) of which there is one for each of the key cylinders. The purpose of the windows to afford visual confirmation that the respective cylinder is in the locked or unlocked position. This is accomplished with rotational indicator components (12) and (11) assembled onto the key entry ends of cylinders (6) and (7). The rotational indicator components FIG. 5 (12) and (11) each have two small pin holes (11-c) and (12-c) that mate with two pin protrusions FIG. 5 (6-a) and (7-a) located on the flat surface of the half-moon protrusions on cylinder (6) and cylinder (7). These pin protrusions and mating pin holes when assembled fix the position of (12) and (11) to cylinder (6) and (7) so that when the cylinders are rotated with the key inserted, the rotational indicator components (12) and (11) rotate as well. The enlarged view of FIG. 5 (11-a) and (11-b) show two areas of the flat surface that will be visible through the indicator windows FIG. 7 (16) and (17). The (11-b) surface would or could be left colorless or a green color for example so that when positioned to be seen through the indicator window (17) and (16) it would represent an unlocked cylinder and the (11-a) surface would or could be colored red and when positioned to be seen through the indicator window (17) and (16) it would represent an locked cylinder. Note that due to the 180 degree corresponding rotation with the cylinder (6) or (7) only (11-b) surface or (11-a) surface would be seen in the appropriate indicator window (16) and-or (17) at any given time.

Combining the visual effect of the key hole security blocking door (10) and the indicator windows {16} and {17} the drawing view FIG. 7 (a) would therefore show that the overall lock is in an UNLOCKED position, i.e. Shackle not locked in the lock body and specifically with both indicator windows (16) and (17) clear or green and the security blocking door (10) blocking key entry to cylinder (6).

Combining the visual effect of the key hole security blocking door (10) and the indicator windows {16} and {17} the drawing view FIG. 7 (b) would therefore show that the overall lock is in a SINGLE cylinder locked position, i.e. Shackle locked in the lock body and specifically with indicator window (17) showing the red surface confirming that the cylinder (7) is in the locked position and clear or green surface showing in the indicator window (16) confirming that cylinder (6) is in the unlocked position. The security blocking door (10) is in the center position therefore not blocking either key entry.

Combining the visual effect of the key hole security blocking door (10) and the indicator windows {16} and {17} the drawing view FIG. 7 (c) would therefore show that the overall lock is in a DOUBLE cylinder locked position, i.e. Shackle locked in the lock body and specifically with indicator window (17) showing the red surface confirming that the cylinder (7) is in the locked position and red surface showing in the indicator window (16) confirming that cylinder (6) is also in the locked position. The security blocking door (10) is blocking cylinder (7) key entry so that only the override double locking key has access to cylinder (6).

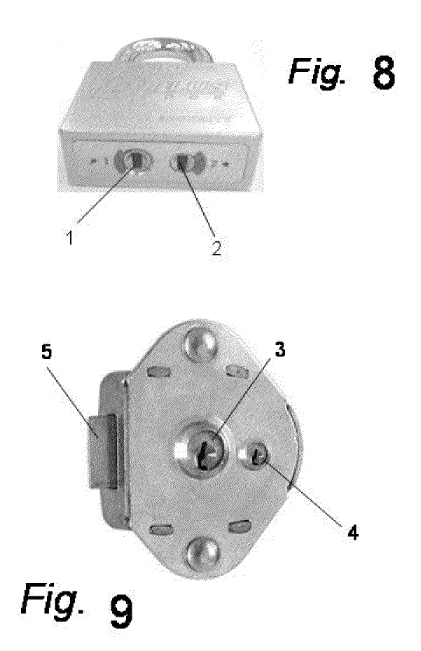

FIG. 8 showing a reference perspective picture of the new invention lock in the form of a padlock with two key entry holes one for each of the two keys required to function this lock in the double locking mode. Cylinder key hole (1) is for locking the lock in a manner consistent with a conventional padlock. Cylinder key hole (2) for inserting a second key that will lock the second cylinder and first cylinder together for the double locking mode. This illustration is configured with two sets of conventional wafer cylinders

FIG. 9 shows an alternate version of the new invention lock in the form of a locker lock commonly used in schools and institutions for student and employee lockers. This type of lock is similar is size and shape for retrofitting onto existing lockers and has the basic double lock features and flexibility of the padlock version used for the purpose of this provisional lock application except that this lock is a deadbolt lock showing the deadbolt (5) in addition to the two separate lock cylinders (3) and (4). Cylinder (4) would be for student or employee use and cylinder (3) would be for authorized security personnel use. The purpose of this illustration is to show an alternate type lock whereby the new invention mechanism can be incorporated to create a different kind of lock with the higher level security features and benefits.

It will thus be seen that the object set forth above, among those made apparent from the preceding description, are efficiently attained and, since certain changes may be made in the above constructions without departing from the scope of the invention, it is intended that all matter contained in the above description or shown in the accompanying drawings shall be interpreted as illustrative and not a limited sense.

It is also to be understood that future claims to be submitted are intended to cover all of the generic and specific features of the invention herein described, and all statements of the scope of the invention which, as a matter of language, might be said to fall there between.

1. A dual cylinder lock comprising:
{a} one conventional wafer or pin cylinder that through its individual key action would block the shackle in a padlock version and a deadbolt in deadbolt locking lock mechanism.
{b} a second conventional wafer or pin cylinder that with a separate individual key that when activated, would block the key entry hole in the first cylinder {a} disallowing the first key entry access and therefore creating a mechanism whereby the second key and cylinder locks the first cylinder when the first cylinder lateral deadbolts are in the locked position.

2. A dual cylinder lock of claim 1, including a key actuated mechanism that allows one cylinder to block key entry access of the second key cylinder.

3. A dual cylinder lock of claim 1, including a key actuated mechanism that activates a window visual indicator for each key cylinder to show its locked or unlocked status at any time it is viewed.
